(19) United States
(12) Patent Application Publication
(10) Pub. No.: US 2016/0054737 A1
(43) Pub. Date: Feb. 25, 2016

(54) Methods and Apparatus for Unmanned Aerial Vehicle Autonomous Aviation

(71) Applicant: Cape Productions Inc., Redwood City, CA (US)

(72) Inventors: Jason Soll, Mountain View, CA (US); Thomas Finsterbusch, Mountain View, CA (US); Louis Gresham, San Mateo, CA (US); Mark Murphy, Redwood City, CA (US); Gabriel Charalambides, Redwood City, CA (US); Alexander Loo, Redwood City, CA (US)

(73) Assignee: CAPE PRODUCTIONS INC., Redwood City, CA (US)

(21) Appl. No.: 14/832,963

(22) Filed: Aug. 21, 2015

Related U.S. Application Data
(60) Provisional application No. 62/041,009, filed on Aug. 22, 2014.
(60) Provisional application No. 62/064,434, filed on Oct. 15, 2014.

(51) Int. Cl. G05D 1/10; B64C 39/02; H04N 5/225; G06T 7/60; G06K 9/52; G05D 1/00; H04N 7/18

(52) U.S. Cl. CPC G05D 1/101; G05D 1/0094; B64C 39/024; H04N 7/185; G06T 7/60; G06K 9/52; H04N 5/2257; B64C 2201/127; B64C 2201/141

(57) ABSTRACT

In some embodiments, an Unmanned Aerial Vehicle (UAV) is configured to navigate to a first location point from a plurality of location points. The plurality of location points defines a flight pattern. The UAV is further configured to receive a set of location coordinates of a moving object. The UAV is configured to determine the distance between the moving object and the UAV based on the set of location coordinates of the moving object and the first location point of the UAV. When the distance between the moving object and the UAV reaches a pre-determined threshold, the UAV is configured to advance to a second location point from the plurality of location points.

### CROSS-REFERENCE TO RELATED APPLICATION

This application claims priority to U.S. Provisional Patent Application Ser. No. 62/041,009, filed on Aug. 22, 2014, and U.S. Provisional Patent Application Ser. No. 62/064,434, filed on Oct. 15, 2014. The contents of the aforementioned applications are incorporated herein by reference in their entirety.

### FIELD OF THE INVENTION

Some embodiments described herein relate generally to methods and apparatus for unmanned aerial vehicle autonomous aviation. In particular, but not by way of limitation, some embodiments described herein relate to methods and apparatus for Unmanned Aerial Vehicles (UAVs) to autonomously track users while avoiding obstacles when filmmaking sporting activities.

### BACKGROUND

An Unmanned Aerial Vehicle (UAV) (also referred herein to as a drone) is an aircraft without a human pilot on board. Its flight is often controlled either autonomously by computers or by the remote control of a human on the ground. When the flight of drones is controlled autonomously by computers, a flight route is often pre-selected for the drones. When the drones are remotely controlled by a human on the ground, the flight is often limited in its range, speed, and/or response time. Especially when drones are used for picture filmmaking of sporting activities (such as skiing and snowboarding events), tracking a skier or keeping the skier in the frame of the camera while avoiding obstacles on the route is important.

Accordingly, a need exists for methods and apparatus for drones to autonomously track users while avoiding obstacles when filmmaking sporting activities.

### SUMMARY

In some embodiments, an Unmanned Aerial Vehicle (UAV) is configured to navigate to a first location point from a plurality of location points. The plurality of location points defines a flight pattern. The UAV is further configured to receive a set of location coordinates of a moving object. The UAV is configured to determine the distance between the moving object and the UAV based on the set of location coordinates of the moving object and the first location point of the UAV. When the distance between the moving object and the UAV reaches a pre-determined threshold, the UAV is configured to advance to a second location point from the plurality of location points.

### BRIEF DESCRIPTION OF THE DRAWINGS

FIG. 1 is a diagram illustrating a drone enabled video recording system, according to an embodiment.

FIG. 2 is a diagram illustrating functions of the wearable device 102, according to an embodiment.

FIGS. 3-4 are diagrams illustrating physical structures of the wearable device 102, according to an embodiment.

FIG. 5 is a diagram illustrating a no-fly zone (505), according to an embodiment.

FIG. 6 is a diagram illustrating a fly zone (605), according to an embodiment.

FIG. 7 is a flow chart illustrating a method for establishing a flight plan along which a drone can safely fly, according to an embodiment.

FIG. 8 is a block diagram illustrating an UAV flight controller 800, according to an embodiment.

FIG. 9 is a diagram illustrating an UAV autonomously tracking a user while avoiding obstacles, according to an embodiment.

FIG. 10 is a flow chart illustrating an UAV autonomously tracking a user while avoiding obstacles 1000, according to an embodiment.

### DETAILED DESCRIPTION

In some embodiments, an Unmanned Aerial Vehicle (UAV) is configured to navigate to a first location point from a plurality of location points. The plurality of location points defines a flight pattern. The UAV is further configured to receive a set of location coordinates of a moving object. The UAV is configured to determine the distance between the moving object and the UAV based on the set of location coordinates of the moving object and the first location point of the UAV. When the distance between the moving object and the UAV reaches a pre-determined threshold, the UAV is configured to advance to a second location point from the plurality of location points.

In some embodiments, an apparatus comprises a processor and a memory communicatively coupled to the processor. The memory stores instructions executed by the processor to establish an initial flight plan of an Unmanned Aerial Vehicle (UAV). The memory further stores instructions executed by the processor to update the initial flight plan based on a spatial safety consideration to form an updated flight plan. The memory stores instructions executed by the processor to store the updated flight plan in the memory and download the updated flight plan from the memory.

As used in this specification, the singular forms “a,” “an” and “the” include plural referents unless the context clearly dictates otherwise. Thus, for example, the term “a moving object” is intended to mean a single moving object or a combination of moving objects.

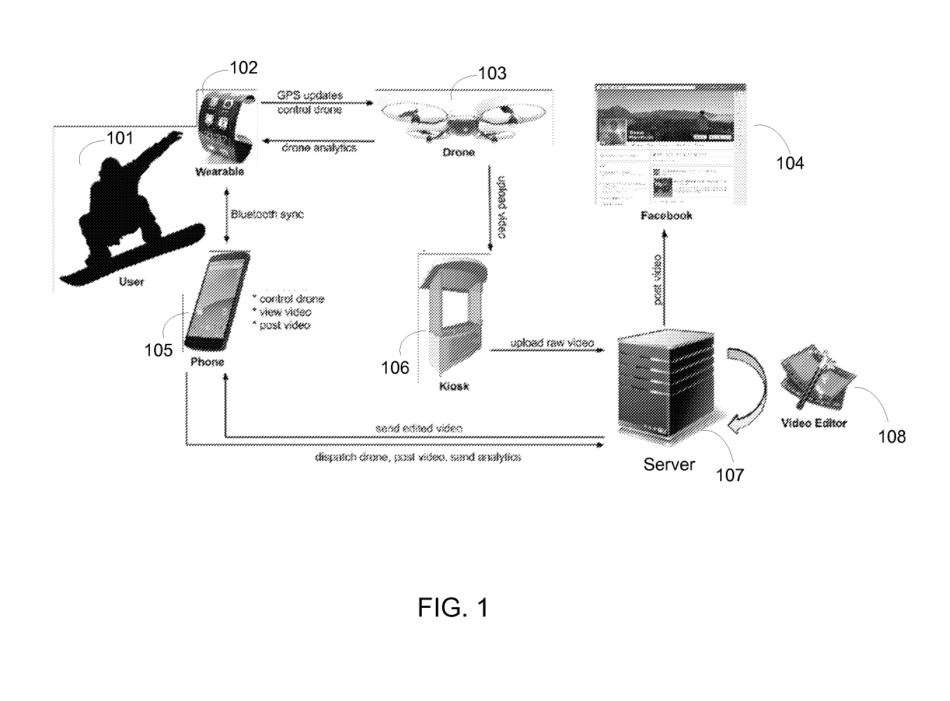

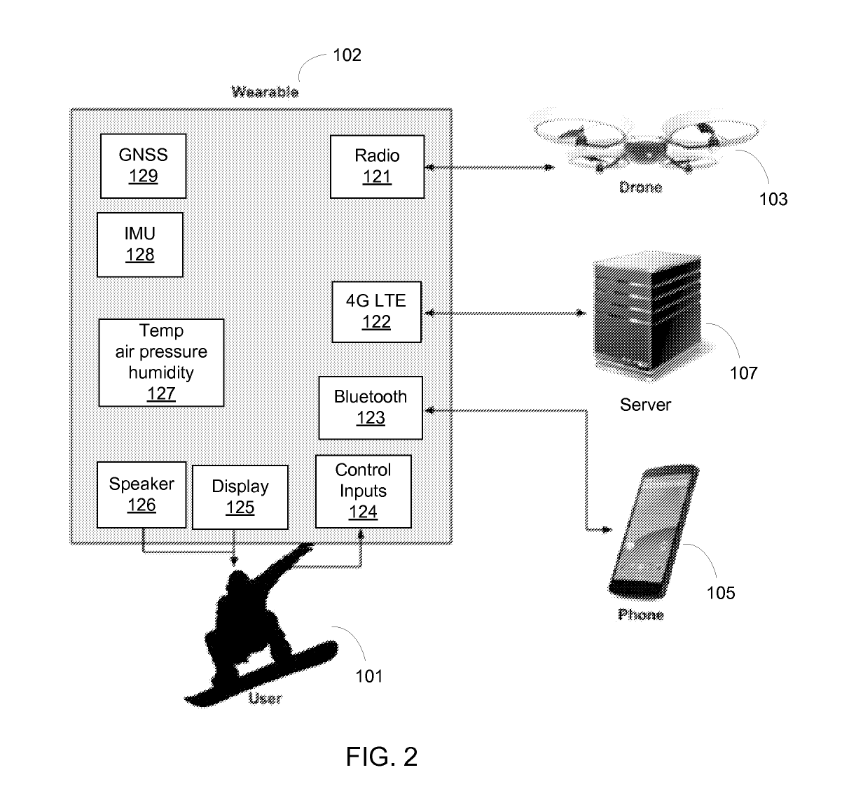

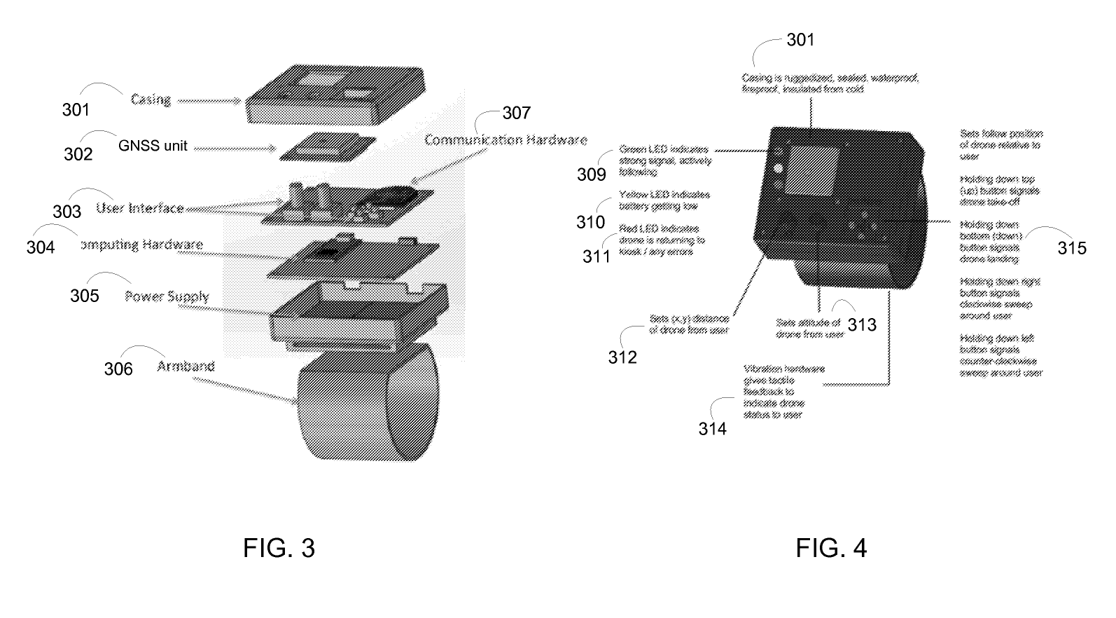

FIG. 1 is a diagram illustrating a drone enabled video recording system, according to an embodiment. In some embodiments, a moving object 101 (also referred herein to as a user) (e.g., a snowboarder in this figure) has a wearable device 102 which can be configured to send Global Navigation Satellite System (GNSS) updates of the moving object to a drone 103. The drone 103 actively tracks the position of the moving object to keep the moving object in a frame of a camera attached to the drone such that a video of the moving object can be recorded during a sporting activity. The wearable device 102 can also be configured to control the drone. For example, the wearable device can control the launch/land, flight route, and/or video recording of the drone. The analytics of the drone (e.g., location coordinates, altitude, flight duration, video recording duration, etc.) can be sent from the drone to the wearable device. The communication medium between the drone and the wearable device can be via radio waves, as illustrated in FIG. 2. Details of the physical structure of the wearable device 102 are described herein in FIGS. 3-4.

In one embodiment, a mobile device 105 associated with the moving object can communicate with the wearable device via Bluetooth. In addition, the mobile device 105 can be used to control the drone, view and/or share recorded videos. A kiosk 106, which can be disposed locally at the sporting activity site, can receive the video recorded by the drone and upload the video to a server 107. The server 107 can communicate with a video editor 108 and/or video sharing websites 104 for post-editing and sharing.

FIG. 2 is a diagram illustrating functions of the wearable device 102, according to an embodiment. In some embodiments, the wearable device 102 can include a GNSS navigation system 129 which provides locations of the moving object 101. The wearable device 102 can include a magnetometer and/or a compass for navigation and orientation. The wearable device 102 can also include an Inertial Measurement Unit (IMU) 128 which provides velocities, orientations, and/or gravitational forces of the moving object 101. The wearable device 102 can also include other devices to measure and provide temperature, pressure, and/or humidity 127 of the environment that the moving object is in. The wearable device 102 can include a speaker 126 to communicate with the moving object 101. The wearable device 102 can also include a microphone (not shown in FIG. 2) which can record audio clips of the moving object. The audio clips can be used later in the process for automatic video editing. Details of the automatic video editing embodiments are discussed in U.S. patent application Ser. No. ______, filed on Aug. 21, 2015, entitled “Methods and Apparatus for Automatic Editing of Video Recorded by an Unmanned Aerial Vehicle”, (Attorney Docket No. CAPE-001/03US 322555-2004), the contents of which are incorporated herein by reference in its entirety.

The wearable device 102 may also include a display device for the user to view analytics associated with the user and/or analytics associated with the drone. The analytics may include location, altitude, temperature, pressure, humidity, date, time, and/or flight route. In some instances, the display device can also be used to view the recorded video. A control inputs unit 124 can be included in the wearable device 102 to allow the user to provide control commands to the wearable device or to the drone. As discussed above with regards to FIG. 1, in some embodiments, the wearable device can communicate to the mobile device 105 via Bluetooth 123, to the server 107 via 4G Long Term Evolution (LTE) 122, and to the drone via radio circuit 121. In some embodiments, the wearable device can communicate to the mobile device 105 via other communication mechanisms, such as, but not limited to, long-range radios, cell tower (3G and/or 4G), WiFi (e.g., IEEE 802.11), Bluetooth (Bluetooth Low Energy or normal Bluetooth), and/or the like.

In some embodiments, the wearable device 102 can be configured to communicate with the drone in order to update it about the user's current position and velocity vector. In some embodiments, the wearable device 102 can be configured to communicate with the backend server to log the status of a user. In some embodiments, the wearable device 102 can be configured to communicate with user's phone to interact with a smartphone app. In some embodiments, the wearable device 102 can be configured to give a user the ability to control the drone via buttons. In some embodiments, the wearable device 102 can be configured to give a user insight into system status via audio output, graphical display, LEDs, etc. In some embodiments, the wearable device 102 can be configured to measure environmental conditions (temperature, wind speeds, humidity, etc.)

In some embodiments, the wearable device is a piece of hardware worn by the user. Its primary purpose is to notify the drone of the user's position, thus enabling the drone to follow the user and to keep the user in the camera frame.

FIGS. 3-4 are diagrams illustrating physical structures of the wearable device 102, according to an embodiment. In some embodiments, the wearable device 102 can include a casing 301, a GNSS unit 302, a user interface 303, computing hardware 304, communication hardware 307, a power supply 305, and an armband 306. The face of the wearable device can include a ruggedized, sealed, waterproof, and fireproof casing 301 which is insulated from cold. The face of the wearable device can also include a green LED 309 which indicates that the drone is actively following the user. A yellow LED 310 can indicate that the battery of the drone is running low. A red LED 311 can indicate that the drone is returning to kiosk and/or there is error. The knob 312 can set (x,y) distance of the drone from the user. Knob 313 can set altitude of the drone. The wearable device can include vibration hardware 314 which gives tactile feedback to indicate drone status to the user. Buttons 315 can set a follow mode of the drone relative to the user. For example, holding down an up button signals drone take-off, holding down a down button signals drone landing. Holding down a right button signals clockwise sweep around a user. Holding down left button signals counter clockwise sweep around the user.

In some embodiments, the wearable device can be in a helmet, a wristband, embedding in clothing (e.g., jackets, boots, etc.), embedded in sports equipment (snowboard, surfboard, etc.), and/or embedded in accessories (e.g., goggles, glasses, etc.).

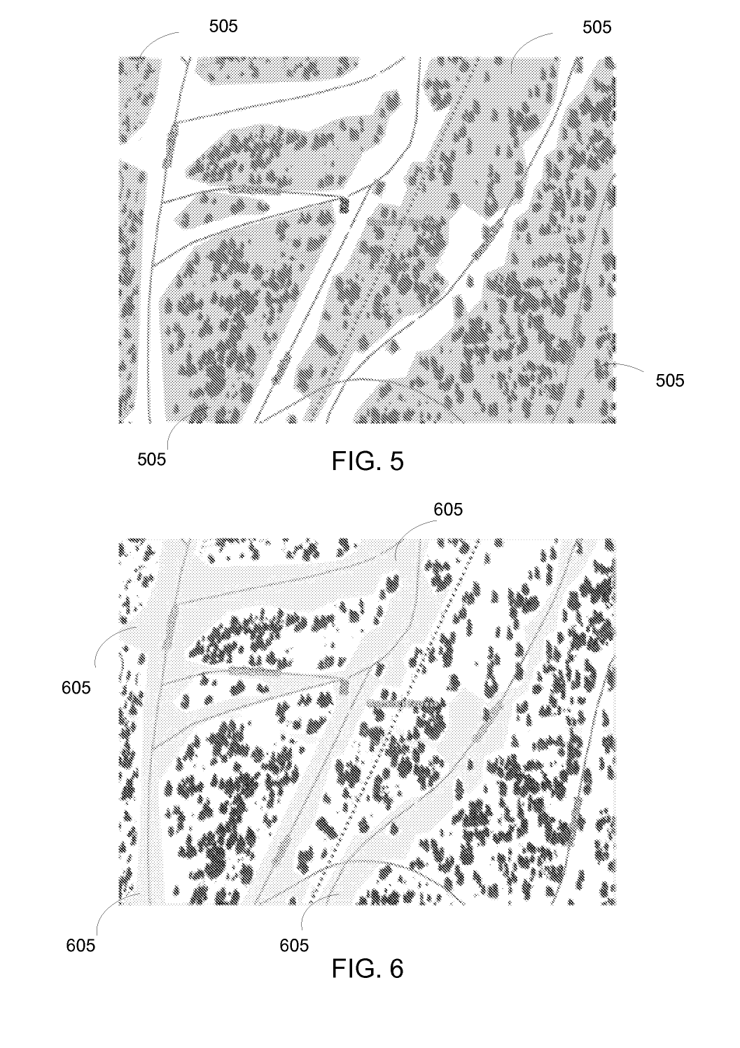

FIG. 5 is a diagram illustrating a no-fly zone (505), according to an embodiment. FIG. 6 is a diagram illustrating a fly zone (605), according to an embodiment. In some embodiments, 3-dimensional boxes in which drones are allowed to fly and/or need to stay away from can be defined. The safety of the drone can be increased by including static obstacles (e.g., trees, chairlifts, power lines, etc.) into no-fly zones. Flight lanes along ski runs that are obstacle free can also be defined to increase safety. Human feedback can be implemented to further optimize the zone definitions. For example, humans can be given a visual interface in which they can draw polygons that define no-fly zones, as illustrated with markings 505 in FIG. 5. Humans can also be given a visual interface in which they can draw polygons that define fly zones, as illustrated with markings 605 in FIG. 6. In other embodiments, the fly/no-fly zones can be automatically derived without human involvement. For example, digital image processing techniques can be used to analyze aerial imagery (e.g., shot from satellites or planes) to automatically derive the boundary boxes. In some instances, the zone definition can be implemented in web interfaces (e.g., Google maps). In some instances, the zone definition can be implemented in a desktop application. In some instances, the zone definition can be implemented in a native Android/iOS app.

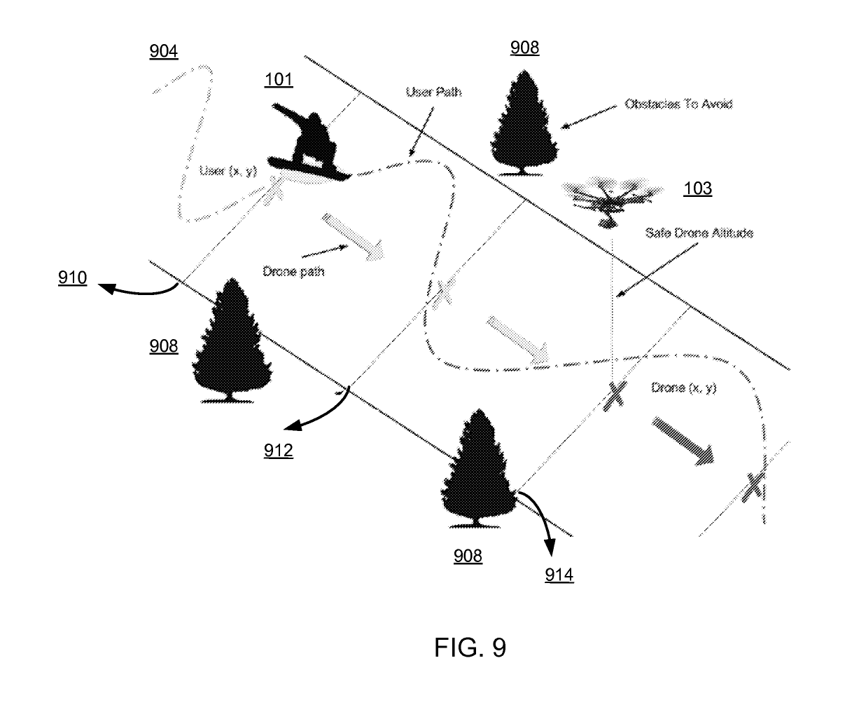

In other embodiments, instead of defining fly/no-fly zones, a flight rail (also referred herein to as a flight plan) along which the drone can fly safely can be defined. A flight rail includes a set of waypoints (x,y,z coordinates) (also referred herein to as a set of location points). When the drone flies from one waypoint (or one location point) to the next one along this rail, the drone will not hit any static obstacle (e.g. tree, chairlift, mountain, etc.) that can be mapped out before the drone is in the air. This can be achieved by picking waypoints that maximize the drone's distance from any static obstacle. For instance, as shown in FIG. 9, the second waypoint (i.e. the second X at 921) is equidistant in the (x,y) plane from the 3 obstacles (e.g., 908). The set of waypoints can be defined within an absolute frame of reference (e.g. GNSS coordinates), or within a relative frame of reference (e.g. 10 meters southwest of the starting point and 3 meters lower than the starting altitude). To increase safety, the drone can be configured to fly at a minimum altitude, such as 12 meter off the ground. The drone's altitude can be determined in multiple ways, including an onboard barometer and onboard laser range finder that is pointing towards the ground. This minimum altitude prevents the drone from colliding with anything that moves along the ground, e.g. the user that the drone is tracking or any other bystanders. In one embodiment, the set of location points of the UAV are spaced equally in distance.

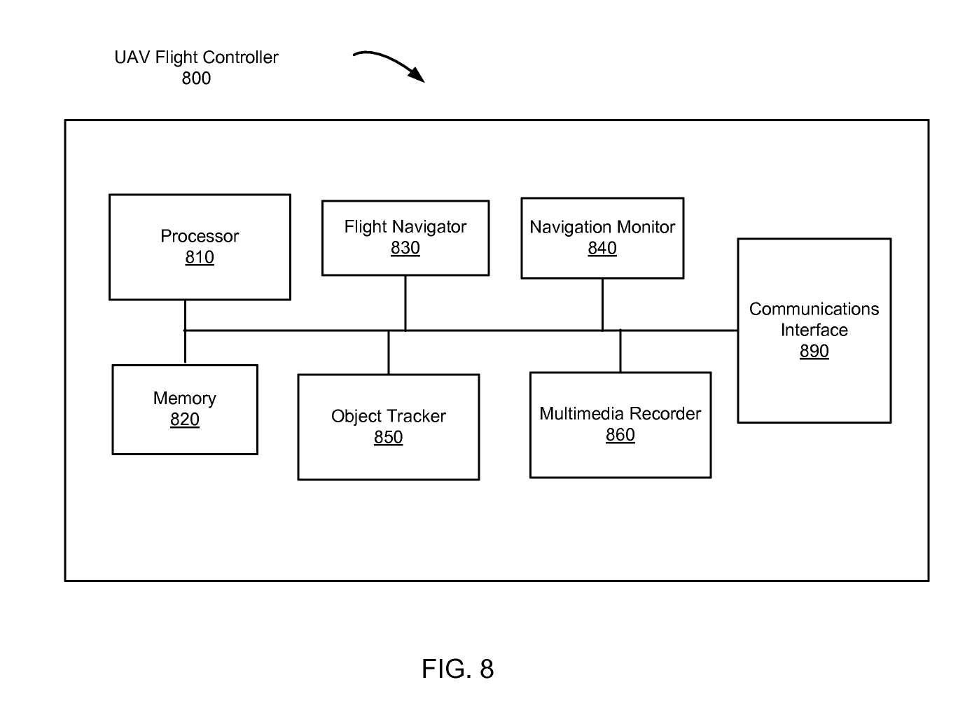

In one implementation, a portable device (not shown in the figures) or the wearable device itself can be configured to measure & record pairs of <latitude, longitude> Global Navigation Satellite System (GNSS) coordinates (e.g. by using a u-blox M-8 GNSS module) as well as measure & record altitude above ground level (i.e. z-coordinate) using a barometer (e.g. the MEAS MS5611). In some instances, the portable device can include a processor (similar to the processor 810 in FIG. 8) to read sensor data and do computations, some storage (e.g. flash and/or a memory similar to memory 820 in FIG. 8), and a battery to power itself.

In this implementation, the portable device can be configured to start recording <lat,lng,alt> triples. The very first recording is the start of the rail. Note that in some instances, the lat & lng measurements can be global coordinates in an absolute system. The barometer, on the other hand, gives relative measurements based on its starting point. The very first recording of the barometer can be set to 0. When the portable device takes 10 meters above ground level (AGL), the reading is +10. When the portable device is taken down a hill, the readings can be negative, e.g. −10. In some instances, this embodiment can be implemented by holding the portable device by a human while snowing down the ski run. While the portable device is recording, the human can physically traverse along the rail to create flattened <lat,lng> values. The safety of the rail can be increased if the distance between the human and any static obstacles, such as trees or power lines or chairlifts, is maximized. In other words, the human should ski along a safe path.

In some embodiments, in addition to the portable device being used by a human to map the rail, an UAV can be used to map out the rail with 3-dimensional details. In such embodiments, a safe rail can be created with an algorithm using the 3-dimensional map gathered by the UAV.

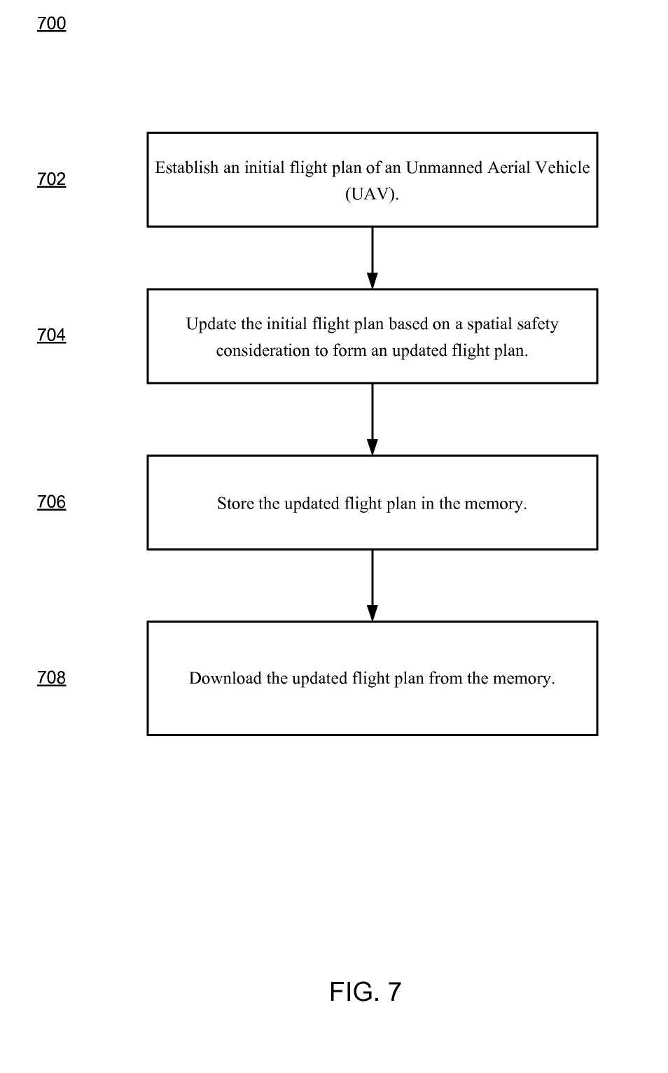

FIG. 7 is a flow chart illustrating a method for establishing a flight plan (also referred herein to as flight rail) along which a drone can safely fly. In some embodiments, the method can be implemented in an apparatus including a processor and a memory communicatively coupled to the processor. The memory stores instructions executed by the processor to, as described above, establish an initial flight plan of an Unmanned Aerial Vehicle (UAV) at 702. For example, this may involve a human skiing along a safe path, as discussed above. Alternatively, this may involve annotating a satellite image to specify a flight path. The memory further stores instructions executed by the processor to optionally update the initial flight plan based on a spatial safety consideration to form an updated flight plan at 704. For example, <lat, lng, alt> triples associated with a safe path followed by a human may be augmented with information about obstacles adjacent to the flight plan. The memory stores instructions executed by the processor to store the updated flight plan in the memory at 706 and download the updated flight plan from the memory at 708. The flight plan is downloaded to drone 103 from server 107. In these embodiments, the flight plan is updated based on a safety consideration prior to autonomously tracking a user by the UAV (e.g., keeping a skier in a frame of a camera on the UAV during ski trip). The plurality of location points on the flight plan do not change when the UAV autonomously tracks the user.

FIG. 8 is a block diagram illustrating an UAV flight controller 800, according to an embodiment. The UAV flight controller 800 can be configured to control the flight of drone and/or other functions of the drone (e.g., multimedia recording). The UAV flight controller 800 can be hardware and/or software (stored and/or executing in hardware), operatively coupled to the UAV. In other embodiments, the UAV flight controller 800 can be hardware and/or software (stored and/or executing in hardware), operatively coupled to the wearable device, mobile device, moving object, and/or the like.

In some embodiments, the UAV flight controller 800 includes a processor 810, a memory 820, a communications interface 890, a flight navigator 830, a navigation monitor 840, an object tracker 850, and a multimedia recorder 860. In some embodiments, the UAV flight controller 800 can be a single physical device. In other embodiments, the UAV flight controller 800 can include multiple physical devices (e.g., operatively coupled by a network), each of which can include one or multiple modules and/or components shown in FIG. 8.

Each module or component in the UAV flight controller 800 can be operatively coupled to each remaining module and/or component. Each module and/or component in the UAV flight controller 800 can be any combination of hardware and/or software (stored and/or executing in hardware) capable of performing one or more specific functions associated with that module and/or component.

The memory 820 can be, for example, a random-access memory (RAM) (e.g., a dynamic RAM, a static RAM), a flash memory, a removable memory, a hard drive, a database and/or so forth. In some embodiments, the memory 820 can include, for example, a database, process, application, virtual machine, and/or some other software modules (stored and/or executing in hardware) or hardware modules configured to execute an UAV flight control process and/or one or more associated methods for UAV flight control. In such embodiments, instructions of executing the UAV flight control process and/or the associated methods can be stored within the memory 820 and executed at the processor 810. In some embodiments, data can be stored in the memory 820.

The communications interface 890 can include and/or be configured to manage one or multiple ports of the UAV flight controller 800. In some embodiments, the communications interface 890 can be configured to, among other functions, receive data and/or information, and send commands, and/or instructions, to and from various devices including, but not limited to, the drone, the wearable device, the mobile device, the kiosk, the server, and/or the world wide web.

The processor 810 can be configured to control, for example, the operations of the communications interface 890, write data into and read data from the memory 820, and execute the instructions stored within the memory 820. The processor 810 can also be configured to execute and/or control, for example, the operations of the flight navigator 830, the navigation monitor 840, the object tracker 850, and the multimedia recorder 860, as described in further detail herein. In some embodiments, under the control of the processor 810 and based on the methods or processes stored within the memory 820, the flight navigator 830, the navigation monitor 840, the object tracker 850, and the multimedia recorder 860 can be configured to execute a UAV flight control process, as described in further detail herein.

The flight navigator 830 can be any hardware and/or software module (stored in a memory such as the memory 820 and/or executing in hardware such as the processor 810) configured to control the flight of the drone.

The navigation monitor 840 can be any hardware and/or software module (stored in a memory such as the memory 820 and/or executing in hardware such as the processor 810) configured to monitor the flight of the drone. The navigation monitor 840 can be configured to monitor the GNSS location, altitude, speed, flight route, battery life, and/or the like.

The object tracker 850 can be any hardware and/or software module (stored in a memory such as the memory 820 and/or executing in hardware such as the processor 810) configured to track the moving object (e.g., 101 in FIG. 1) to keep the moving object in the frame of the camera, as well as stay away from obstacles.

The multimedia recorder 860 can be any hardware and/or software module (stored in a memory such as the memory 820 and/or executing in hardware such as the processor 810) configured to send commands to multimedia devices (e.g., camera) to start, stop, and/or edit a multimedia segment.

FIG. 9 is a diagram illustrating an UAV autonomously tracking users while avoiding obstacles, according to an embodiment. In these embodiments, the user 101 indirectly controls how the UAV moves along this rail. The rail is created similar to the process described in FIG. 7. When the UAV 103 is staying at a given waypoint (i.e., location point) and is hovering at the waypoint, the UAV can advance to the next waypoint along the rail, when the user reaches a minimum threshold distance away from the UAV. In other words, there are imaginary barriers set up (depicted as broken lines 910, 912, 914). When the user crosses one of these barriers, the drone will automatically advance to the next waypoint along its set rail. In some instances, the user can carry a wearable device such as the one described in FIGS. 3-4. This device wearable can communicate with the drone, and update the drone about the user's current location and speed vector at a certain frequency (e.g., 50 times a second). This information in turn can be used to compute whether the UAV should advance to the next waypoint.

An alternative way of computing how close the user is to the UAV, and whether the UAV should advance, is via computer vision. Here, the live video stream from the drone's camera is analyzed. This visual information can be used to compute the user's distance from the UAV.

Other data streams that can be used to measure distance between UAV and user include infrared/thermal cameras, RFID, bluetooth, wifi, cell phone signal, etc.

In some instances, the gimbal that carries the camera on the UAV can be controlled independently of the UAV's flight motions. For instance, when the UAV itself is hovering in place at a given waypoint, the gimbal can move the camera along 3 axes in such a way that the user stays in frame of the camera. This can also be achieved when the user is traveling along elaborate curves (e.g. such as when skiing/snowboarding down a run).

In some embodiments, instead of tracking the user based on a minimum threshold distance from the UAV, the UAV can also be configured to track the user by using the user's velocity. In one implementation, the UAV can fly at a velocity that substantially matches the user's velocity. In another implementation, the UAV's velocity can be commanded along the rail based on a distance from the user. In other words, when the UAV is at a certain distance away from the user, for example, the velocity of the UAV is zero as the user gets closer to the UAV. The velocity of the UAV changes (e.g., increases) along the rail based on a mapping function from a distance between the UAV and the user to the velocity of the UAV along the rail.

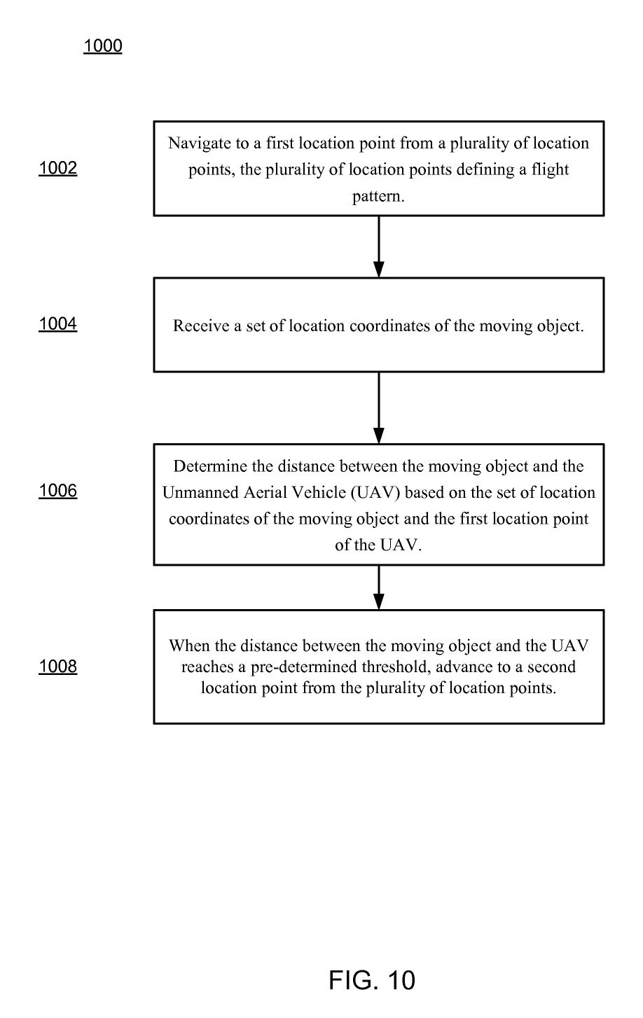

FIG. 10 is a flow chart illustrating an UAV autonomously tracking users while avoiding obstacles 1000, according to an embodiment. In some embodiments, an Unmanned Aerial Vehicle (UAV) navigates to a first location point from a set of location points at 1002. The set of location points defines a flight pattern. The UAV receives a set of location coordinates of a moving object at 1004. The UAV determines the distance between the moving object and the UAV based on the set of location coordinates of the moving object and the first location point of the UAV at 1006. When the distance between the moving object and the UAV reaches a pre-determined threshold, the UAV advances to a second location point from the plurality of location points at 1008.

An embodiment of the present invention relates to a computer storage product with a non-transitory computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media, optical media, magneto-optical media and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA@, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

What is claimed is:

1. An Unmanned Aerial Vehicle (UAV), configured to:
navigate to a first location point from a plurality of location points, the plurality of location points defining a flight pattern;
receive a set of location coordinates of a moving object;
determine the distance between the moving object and the UAV based on the set of location coordinates of the moving object and the first location point of the UAV; and
when the distance between the moving object and the UAV reaches a pre-determined threshold, advance to a second location point from the plurality of location points.

2. The Unmanned Aerial Vehicle of claim 1, further configured to:
record a video of the moving object from a camera disposed on the UAV.

3. The Unmanned Aerial Vehicle of claim 1, further configured to:
monitor a velocity vector of the moving object; and
adjust a velocity vector of the UAV such that the UAV advances along the flight pattern at a speed corresponding to the speed of the moving object.

4. The Unmanned Aerial Vehicle of claim 1, further configured to:
monitor the distance between the moving object and the UAV based on data from computer vision produced from a camera disposed on the UAV.

5. The Unmanned Aerial Vehicle of claim 1, further configured to:
monitor the distance between the moving object and the UAV based on data received from the moving object.

6. The Unmanned Aerial Vehicle of claim 1, further configured to:
record a video of the moving object from a camera disposed on the UAV; and
adjust a gimbal head of the camera such that the moving object stays in a frame of the camera.

7. The Unmanned Aerial Vehicle of claim 1, wherein the set of location coordinates of the moving object includes is a pair of Global Navigation Satellite System (GNSS) coordinates.

8. The Unmanned Aerial Vehicle of claim 1, wherein the set of location coordinates of the moving object includes coordinates relative to a reference location.

9. An apparatus, comprising:
a processor; and
a memory communicatively coupled to the processor, the memory storing instructions executed by the processor to:
establish an initial flight plan of an Unmanned Aerial Vehicle (UAV);
update the initial flight plan based on a spatial safety consideration to form an updated flight plan;
store the updated flight plan in the memory;
download the updated flight plan from the memory.

10. The apparatus of claim 9, wherein the initial flight plan includes a plurality of location points, the plurality of location points being spaced evenly along the initial flight plan.

11. The apparatus of claim 9, wherein the spatial safety consideration includes a distance between the initial flight plan and an obstacle.

12. The apparatus of claim 9, wherein the memory stores instructions executed by the processor to:
update the initial flight plan based on a distance between an obstacle and a nearest location point from a plurality of location points in the initial flight plan such that the distance between the obstacle and the nearest location point is maximized.
